(19) United States
(12) Patent Application Publication
(10) Pub. No.: US 2024/0185300 A1
(43) Pub. Date: Jun. 6, 2024

(54) PREDICTIVE ADVERTISING SYSTEMS AND METHODS WITH INTEGRATED SAFETY AND PRIVACY FEATURES

(71) Applicant: THEATRICALITY LLC, Los Angeles, CA (US)

(72) Inventor: Christopher Scott BIRD, Medellin (CO)

(73) Assignee: THEATRICALITY LLC, Los Angeles, CA (US)

(21) Appl. No.: 18/527,524

(22) Filed: Dec. 4, 2023

Related U.S. Application Data
(60) Provisional application No. 63/386,250, filed on Dec. 6, 2022.

(51) Int. Cl. G06Q 30/0251

(52) U.S. Cl. CPC G06Q 30/0267; G06Q 30/0266

(57) ABSTRACT

Predictive advertising systems and methods suitable for use in a mobile environment are disclosed. The predictive advertising systems and methods include safety and privacy features. The predictive outcomes may include, for example, predicting behavior of the transportation devices, including whether the surrounding vehicles are fully stopped, or soon will be fully stopped, and if so, the predicted length of time that they will remain fully stopped. This information can be used to control an advertising output from the system.

### CROSS-REFERENCE

This application claims the benefit of U.S. Provisional Application No. 63/386,250, filed Dec. 6, 2022, entitled PREDICTIVE ADVERTISING SYSTEMS AND METHODS which application is incorporated herein in its entirety by reference.

### BACKGROUND

Field: The present disclosure relates to predictive advertising systems and methods with integrated safety and privacy features suitable for use in a mobile environment.

Automobiles, buses, trolleys, trains, taxis, and/or other forms of transportation devices are widely used to facilitate movement from one location to another: home to work; work to the store; etc. Static advertisements are often present on the exterior surfaces of the transportation devices and/or positioned within an interior of the transportation device. Even with transportation options, many people use their own vehicles for transportation. In large cities such as Los Angeles, many people spend long periods of time driving to and from locations such as home to work, as well as driving to and from shopping locations, stores, etc.

More recent advances in technology have allowed people to use their own vehicles for “ridesharing” or “ride sourcing” vehicles through companies such as Uber® and/or Lyft®. Ridesharing companies allow for use of cellular telephones and other communications techniques to create a private taxi fleet, which techniques can alert drivers that a person needs a ride from their current location to another location. The system then provides information to the driver and potential passenger, and connects the driver and passenger for the designated trip. In this way, the drivers of private vehicles are provided with a means of participating in a commercial enterprise, offering the opportunity to earn income while they drive.

When driving a vehicle, there are many advertisements placed where drivers/passengers can see them, e.g., billboards, buildings, storefronts, and other locations where businesses can be identified to a driver. Many of these locations are not directly in the driver's field of view, however, and require the driver to divert his/her attention to the billboard, storefront, etc., and away from the traffic that is closest to their vehicle. What is needed is predictive advertising systems and devices, with integrated safety and privacy features, that are suitable for use in a mobile environment.

### SUMMARY

Disclosed are systems, methods and devices for presenting advertisements and content in a mobile environment. Also disclosed are systems, methods and devices for delivering predictive advertising and content delivery systems with integrated safety and privacy features.

Both the foregoing general description and the following detailed description are exemplary and explanatory only and are not restrictive of the disclosed embodiments, as claimed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.
US 2007/0011051 A1 published Jan. 11, 2007 by Findlay et al.;
US 2008/0172781 A1 published Jul. 24, 2008 by Popowich et al.;
US 2010/0250368 A1 published Sep. 30, 2010 by Porco;
US 2010/0259058 A1 published Oct. 14, 2010 by Knighton et al.;
US 2012/0303458 A1 published Nov. 29, 2012 by Schuler Jr.;
US 2013/0304565 A1 published Nov. 14, 2013 by Saccoman;
US 2014/0344062 A1 published Nov. 20, 2014 by LaMont;
US 2014/0040016 A1 published Feb. 6, 2014 by Amla et al.;
US 2019/0251600 A1 published Aug. 15, 2019 by Cabrera et al.;
US 2020/0410541 A1 published Dec. 31, 2020 by James;
US 2021/0012382 A1 published Jan. 14, 2021 by Bird;
US 2021/0125227 A1 published Apr. 29, 2021 by Lee et al.;
US 2021/0350412 A1 published Nov. 11, 2021 by Harwood et al.;
US 2021/0350414 A1 published Nov. 11, 2021 by Kardesler et al.;
US 2021/0374805 A1 published Dec. 2, 2021 by Gaither;
US 2021/0406957 A1 published Dec. 30, 2021 by Riley et al.;
U.S. Pat. No. 7,449,998 B1 issued Nov. 11, 2008 by Au et al.;
U.S. Pat. No. 9,087,465 B2 issued Jul. 21, 2015 by Griffin et al.;
U.S. Pat. No. 9,775,003 B2 issued Sep. 26, 2017 by Ciecko et al.;
U.S. Pat. No. 9,934,709 B2 issued Apr. 3, 2018 by Lanham;
U.S. Pat. No. 10,416,947 B2 issued Sep. 17, 2019 by Zenoff et al.;
U.S. Pat. No. 10,636,335 B2 issued Apr. 28, 2020 by Pinero et al.;
U.S. Pat. No. 10,665,155 B1 issued May 26, 2020 by Rao;
U.S. Pat. No. 10,740,796 B2 issued Aug. 11, 2020 by Brubaker;
U.S. Pat. No. 10,762,809 B1 issued Sep. 1, 2020 by DeLorcan;
U.S. Pat. No. 10,957,227 B2 issued Mar. 23, 2021 by DeLorean;
WO 2009/039350 A1 published Mar. 26, 2009 by Slowe et al.; and
WO 2021/154418 A1 published Aug. 5, 2021 by Tuckman et al.

### BRIEF DESCRIPTION OF THE DRAWINGS

The novel features of the invention are set forth with particularity in the appended claims. As will be appreciated by those skilled in the art, the various features illustrated in the drawings may not be drawn to scale. Moreover, the illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

A better understanding of the features and advantages of the present invention will be obtained by reference to the following detailed description that sets forth illustrative embodiments, in which the principles of the invention are utilized, and the accompanying drawings of which:

FIGS. 1A-C are views of an automobile in accordance with an aspect of the present disclosure;

FIG. 2 illustrates a block diagram of a system in accordance with an aspect of the present disclosure;

FIG. 3 illustrates a display in accordance with an aspect of the present disclosure;

FIG. 4 illustrates a mounting device in accordance with an aspect of the present disclosure;

FIG. 5 illustrates a controller in accordance with an aspect of the present disclosure;

FIG. 6 is a block diagram that illustrates and exemplary scenario for generating a predictor model; and

FIG. 7 is a flow chart that illustrates a method for delivering predicted content.

### DETAILED DESCRIPTION

The present disclosure is directed toward a mobile advertisement system that is coupled to a vehicle. Advertisements, data, messages, or entertainment are sent to the vehicle wirelessly, and exteriorly displayed at or from a rear, a side, a front or a top of the vehicle. Video content or other dynamic content is displayable when sensors indicate that the vehicle and at least one adjacent vehicle have come to a complete stop. Static images are displayable when the vehicle or at least one adjacent vehicle is in motion. The driver of the vehicle receives payment for the static and dynamic advertisements displayed.

### Overview

A display screen is provided that can be affixed to a transportation device or vehicle (car, truck, bus, train, motorcycle, boat, aircraft, etc.) either on an exterior surface or on an interior surface. When the device is affixed internally, the display screen can be positionable to be viewable by the adjacent vehicle(s). The display screen is configurable to operate in combination with a software program or application that connects wirelessly to the worldwide web, cloud, server, etc., either directly or indirectly (e.g., via a mobile device, hot spot, or computer positioned in or on the transportation device or vehicle to which the display screen is affixed).

The mobile device, such as a cell phone, can include a camera, a microphone, and a speaker. The mobile device can also include one or more of a GPS sensor, a WiFi connector, and a Bluetooth connector. The microphone is operable to detect verbal instructions from a user.

The software program or application facilitates the display of interactive, targeted, location-based advertising, data, entertainment, messaging and/or other content to the occupants of surrounding transportation devices wherein the location-based advertising, data, entertainment, messaging and/or other content is delivered after analyzing input received from the surrounding area and predicting behavior of the transportation devices, including whether the surrounding vehicles are fully stopped, and if so, the predicted length of time that they will remain fully stopped.

As discussed below, one or more auxiliary power sources can be provided, such as supplemental batteries. The power sources can be part of a dual function that includes a restricted circuit battery system to facilitate media display when a vehicle engine is not running and one or more supplemental batteries are provided to power the system when the vehicle engine is not running. The auxiliary power sources are operable to control which power source a device uses. A restricted circuitry battery system can be provided to facilitate control of which power source to use.

### System Descriptions

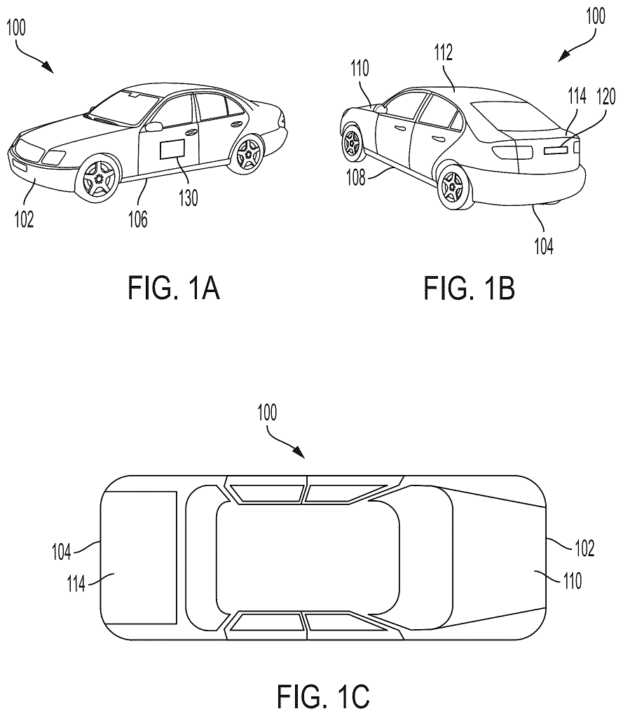

FIGS. 1A-C is a view of an exemplar transportation device or vehicle 100. The vehicle is a system transporting vehicle. The vehicle is, for example, an automobile that comprises a front side 102, back side 104, right side 106, left side 108, trunk surface 114, roof surface 112 and front hood 110. A license plate 120 may be positioned on at least a rear facing surface of the vehicle 100 and/or the front facing surface of the vehicle. The exemplar device is a system transporting vehicle, e.g., a vehicle that incorporates or transports a device operating the system. Vehicles in the vicinity of the system transporting vehicles are detected vehicles, e.g., vehicles detected by the system from the transporting vehicle.

A display 130 is affixable, internally or externally, to a surface of the vehicle 100. For purposes of illustration the display 130 is shown on a side door of the vehicle. Alternatively, the display 130 can be on the back side 104 near the trunk surface 114, the roof surface 112, etc. The display 130 may have a housing that contains a screen, and/or a camera, and/or a computer, and/or a power source; or the screen or other components may not be encased in a housing, or may be contained within the vehicle. The display 130 may be affixable so that the display 130 is directed in a first direction and a camera is directed in a second direction different than the first direction. Alternatively, the display 130 may be affixable so that the display 130 and the camera are both positioned to face the same direction. Alternatively, there may be multiple cameras and screens positioned to face in multiple directions. Suitable displays include, but are not limited to liquid crystal display (LCD), light-emitting diode backlit LCD, thin-film transistor LCD, quantum dot (QLED) display, OLED, etc.

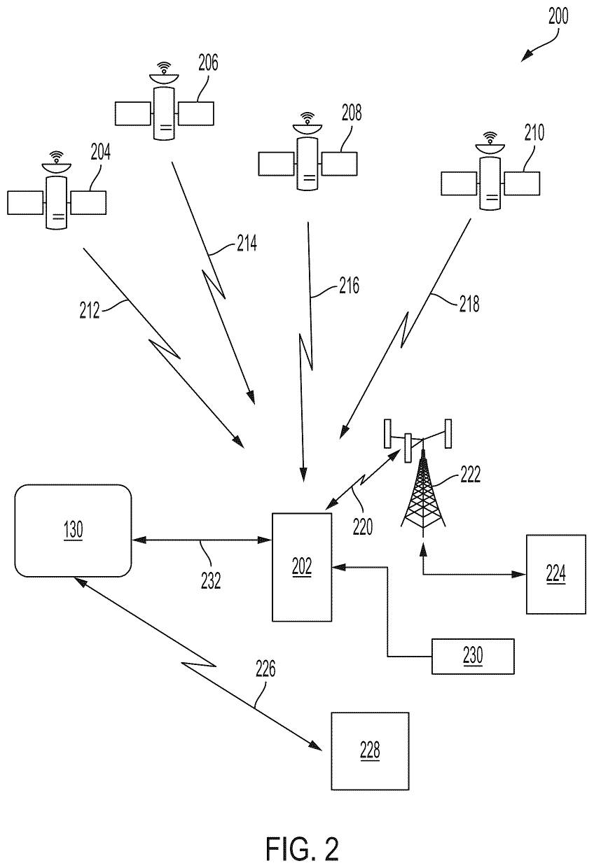

FIG. 2 illustrates a block diagram of a system in accordance with an aspect of the present disclosure. System 200 comprises display 130 and, in some configurations, a device 202. Device 202 may be a wireless device such as a cellular telephone, or may be a separate device such as a computer or processor that has capabilities to determine location and receive and transmit wireless communications; or may include some interactive combination of such devices. The system has computer executable instructions on one or more devices. Device 202 may be a cellular telephone with geolocation and wireless communications capabilities, and is described as such herein. However, other devices 202 are possible, including devices that are integrated with and/or part of display 130, or devices that are integrated with and/or part of the global position system (“GPS”) or other integrated components of a vehicle, without departing from the scope of the present disclosure.

Device 202 may receive communications signals 212, 214, 216, 218 from one or more satellites 204, 206, 208, 210. Device 202 may receive communications signals from additional satellites, or from other sources, in order to, for example, determine the geolocation of device 202.

Device 202 may also transceive one or more signals 220 from a cellular communications tower 222. Signals 220 may be sent from external sources 224 to device 202 via cellular communication tower 222. Signals 226 may also be sent to/from display 130 directly from system 228. System 228 may be a navigation system, computer system, and/or other electronics system(s) in vehicle 100. Device 202 may also be coupled to or incorporate one or more sensors 230.

As device 202 determines a geolocation of the device 202, and receives information and instructions from, for example, external sources 224, e.g., which advertisements, data, entertainment, or messaging to display, etc., and sensors 230 determine, for example, whether driving (movement) and/or other circumstances have changed, device 202 communicates with display 130 via signals 232 to display one or more advertising, data, entertainment, messaging and/or other content. The selection of advertisement, data, entertainment, messaging and content can be dynamic (e.g., a video content) when the device determines that there is no movement, or static (e.g., an image or logo) when the device determines that there is movement. Signals 232 may be sent wirelessly between display 130 and device 202, or may have a hard-wired connection between display 130 and device 202, as desired.

The display 130 may be merely a display screen with a wireless transmitter/receiver, such that technology contained in a cellular telephone can be utilized when device 202 is a cellular telephone. As such, display 130 may act as a remote display for device 202 for the advertising, data, entertainment, messaging and/or other content, and device 202 may be used in parallel by a driver/passenger for other functions. In another aspect of the present disclosure, display 130 may have a dedicated and/or integrated device 202 for the functions/displays described as part of the present disclosure.

Although shown as a single display 130, display 130 may comprise multiple display screens, e.g., one display on each side of license plate 120, or one above and one below the license plate 120, one on the front and back of the vehicle, one on the right side and left side, etc. The plurality of displays 130 may display identical content, or display content in sequence or relation with one another, or display content dictated by the behavior of the vehicles viewing each particular screen. By way of example, if the adjacent vehicles behind and to the right of vehicle 100 are all fully stopped, but the adjacent vehicles to the left of vehicle 100 are in motion, then the screens on the rear and right side of vehicle 100 might display video images (e.g., dynamic content), whereas the screen on the left side of vehicle 100 might display a static image (e.g. static content), so as not to overly distract the drivers of the moving vehicles. A system which merely displays different content when sensors indicate that one adjacent vehicle is moving versus when one adjacent vehicle is stopped may not be equipped to recognize a complex environment where some adjacent vehicles are in motion and some are not; and accordingly a system with such limitations may provide more limited advertising opportunities and/or more limited safety features. For maximum safety and utility, the sensors must analyze the full environment on all sides of the car and adjust the programming in relation to this dynamic environment.

Further, although described as a display 130, which may evoke embodiments similar to those used on cellular telephones, tablets, etc., display 130 may be an electronic projection system that is configurable to project an image onto the rear side of a non-electronic screen, causing the image to be visible to another vehicle. In such a configuration, the screen might be attached to the vehicle 100 in various ways, some of which are similar to those described herein. The image displayed may also be projected from a projector located elsewhere in the vehicle 100 as desired, or the display 130 may, for example, be projected through or onto the rear window of the vehicle 100 from a projector located inside the cabin of the vehicle 100.

A display 130 with a flexible Organic Light Emitting Diode (“OLED”) screen can be provided rather than a traditional, rigid tablet type screen. This flexible OLED screen can be affixed to the vehicle 100 surface and/or the surface of the vehicle 100 rear window. The flexibility of a display 130 implementing flexible technology may allow for better alignment of display 130 with the contours of vehicle 100 surfaces. Other embodiments of system 200 may incorporate display 130 into vehicle 100 during the vehicle 100 manufacturing process. The display has a front side and a back side with the front side comprising a display face or screen that presents the selected content.

Display 130 may also be concealed or partly concealed and adjusted to a viewing position when designated by the driver, system 200, sensor 230 signal, and/or other factors. Such an embodiment may include additional advantages over a fixed display 130, e.g., the ability to secure the system 200 when the vehicle 100 is parked and/or traveling at speeds that might damage the system 200, as well as the ability to move display 130 for better viewing by other vehicles.

The display 130 may also include, alternatively and/or additionally, a holographic image that is projected, for example projected externally to the vehicle near the exterior of the vehicle.

The system can optionally include a driver panic feature or panic button feature. The panic feature allows a driver to activate a panic alert either on their phone app, a button installed in their car, or other device. The panic feature may be implemented so that the driver can covertly activate the feature without attracting attention from passengers in vehicle 100, and may generate an emergency message on display 130 stating that the driver is in danger and requesting that other drivers of other adjacent vehicles call the police. Alternatively, the panic feature may not generate any message for display to surrounding vehicles. The panic feature may activate a communication to a third party (which can be the police) that the driver is experiencing a dangerous or threatening situation, which can include robbery, carjacking, kidnapping, collisions or other traffic incidents, and so on. When a panic signal is transmitted to the cloud, the system's GPS tracking feature can be used to pinpoint and track the location of the driver's vehicle, and to send this information to the police or other appropriate organization to provide assistance. When the vehicle is in motion, the updated information can also be provided. In some configurations, a microphone function can be activated with a mute speaker to allow emergency services to hear what is transpiring within the vehicle.

When sensors detect certain activities or behavior of the vehicles following or adjacent to the screen vehicle, sensor-triggered messages can be operable to override the current advertising content to provide different content. The sensor triggered change in content can be triggered, for example, if another vehicle is tailgating the screen vehicle, and deliver the message: “Please don't tailgate!” In another example, if a following vehicle is using its bright headlights: “Please dim your headlights!” If a following vehicle is weaving in and out of its lane repeatedly, characteristic of a drunk driver: “Dangerous driving detected! Please drive carefully!” Additionally, a distress signal can be provided. The driver of the screen vehicle does not need to activate these messages, they are triggered in response to input from the sensors.

The system is also operable to predict what advertisements a following driver will be responsive to by prompting the driver to respond to certain screen messages. For example, the screen might display the message: “Flash your lights if you love Peach Pic.” If the sensors detect that the driver has flashed his/her lights, the screen displays an ad for a free serving of peach pic at a nearby restaurant. If the sensors do not detect lights flashing, then the system can ask about various other products for which promotions can be offered. System prompts of this type may operate without any initiation or participation of the driver of vehicle 100.

### Display Operation

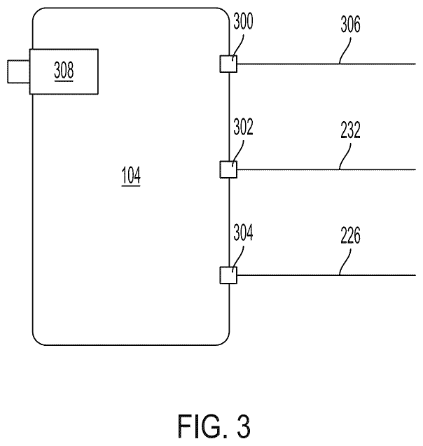

FIG. 3 illustrates a display in accordance with an aspect of the present disclosure. Display 130 has one or more connections 300, 302, 304. The one or more connections 300, 302, 304 receives power input 306 for powering display 130, as well as for powering system 200 if an external power source is required. Power input 306 may be an external battery, or may be an input of energy to charge a battery that is internal to display 130. For example, and not by way of limitation, power input 306 may be inputs from a solar cell, and/or may be leads from an external battery or from the vehicle 100 electrical system, such as through charging ports in vehicle 100, connecting to an existing vehicle 100 light and/or power sources, connection directly to the battery of the vehicle, or other means. Power input 306 may be contact charging through the body of the vehicle 100, or through other locations if desired. Multiple power sources with or without differentiated functions may provide power to display 130 or system 200. In one such example, system 200 may be powered by the primary battery of vehicle 100 when the vehicle engine is running and the battery is being charged by the engine; but when vehicle 100 is stationary with the engine off, system 200 may be powered by a secondary battery system consisting of one or more batteries, allowing system 200 to operate when vehicle 100 is parked with the engine off. An optimal version of this system would have a circuitry design such that if the secondary battery system became fully discharged, system 200 would shut down, without the vehicle's primary battery becoming discharged; but when the vehicle's engine is running, both the primary battery and the secondary battery system would be charged by the engine. When the display 130 indicates that the connections 300, 302, 304 have a power input 306 that is low, display 130 can send a message to device 202 via connection 302/signals 232 that a low power condition has been reached.

Display 130 may also comprise a camera 308 that faces in the same direction as the displayed content, such as advertisement. As such, camera 308 may view the scene behind vehicle 100 (e.g., device scene), or to a side of the vehicle 100, and may transmit the visual information of the scene behind vehicle 100, or to the side of vehicle 100, including information about the exact proximity of an immediately following vehicle, adjacent vehicle or subsequent following vehicle, to device 202 via signals 232. Device 202 may then assess the characteristics of the scene behind or adjacent the vehicle 100, and may monitor the scene for any changes in the scene, e.g., vehicles changing lanes, brand indicators on vehicles behind vehicle 100, license plates of vehicles, whether vehicles behind or adjacent vehicle 100 are moving, standing still, accelerating or decelerating, as well as rates of acceleration/deceleration, number of occupants in a vehicle, etc. Alternatively, one or more cameras 308 may be placed on or in the vehicle 100 in a different location from the display but connected to display 130 or system 200 by a wired or wireless connection, and may monitor the surrounding scene outside the vehicle 100 in the same manner as the camera 308 connected to the display, or optionally may monitor the content appearing on the display, providing visual confirmation (either recorded or in real time) that the display is functioning properly and displaying the intended content. Content can be displayed for a display time which is determined by the system as discussed herein.

Because display 130 and/or device 202 can identify vehicle proximities, sizes, speeds, makes/models, whether vehicle 100 is moving and whether vehicles around vehicle 100 are moving, and/or other characteristics, system 200 can employ the gathered information, in combination with relevant geolocation data such as the location of nearby businesses (e.g., businesses proximate to the GPS location), to determine which advertisements might be applicable to the vehicles behind vehicle 100, and display the proper advertisements to such vehicles. Further, advertisements may be “local” in that if vehicle 100 is on a specific road, then local businesses may have advertisements displayed on vehicle 100; if vehicle 100 is on a different road, or a freeway, different advertisements may be displayed by vehicle 100/system 200

When vehicle 100 is moving, a static media, or periodically rotating display of static images or advertisements, may be presented on display 130. Suitable static images include but are not limited to names or logos of companies, sports teams, or other brands; photos; brief printed messages; and so on. When vehicle 100 is stopped, and the vehicle(s) behind vehicle 100 and/or adjacent to vehicle 100 are also stopped and therefore less at risk of colliding with another vehicle, system 200 may transition to dynamic content, such as a video advertisement or entertainment. Suitable dynamic content include but are not limited to movie trailers or commercials advertising products or businesses; or entertainment content such as short animated or live action videos. The length of time of the display can vary depending on a predicted length of time for a stop. System 200 may prohibit the display of video at any time when vehicle 100 is moving, or when a vehicle behind or adjacent to vehicle 100 is moving. Moving can include very slow or “creeping” movement, for reasons of safety, without the possibility for override by driver, advertiser, or others. As vehicle 100 transitions from a stopped position to an accelerating/moving vehicle, system 200 can switch from dynamic content, such as video advertisement, to a display of static content to reduce driver distraction.

The display screen can optionally feature a “directional safety function.” The directional safety function can be incorporated into the display screen or can be a secondary device affixed to the display screen, and can be active at all times or active only when at least one sensor indicates that at least one adjacent vehicle is in motion. The directional safety function is operable so that the content displayed by the screen is visible to a following vehicle only when the viewer in the following vehicle is directly behind the screen, or at a view angle of approximately 90 degrees. For a viewer located, for example, at a view angle that is 45 degrees to the left or right of the screen, the content on the screen will not be visible. The directional safety function works in a similar way to the plastic privacy screens/overlays that are currently used on the screens of mobile devices and computer monitors. The directional safety function improves safety by allowing content on the screen to be visible to a viewer in a following vehicle directly behind the screen when at least one sensor indicates that the following vehicle has stopped completely, while preventing the drivers of other vehicles in other adjacent traffic lanes from viewing the screen, to avoid distracting those drivers at such times as their vehicles might be in motion.

The display may optionally include a light-sensing brightness adjustment safety feature, allowing the brightness of the image or video shown on the display to automatically adjust in relation to the precise level of light detected by a sensor of system 200. In this way, as the ambient light level decreases, for example due to the onset of night, or vehicle 100 entering a tunnel or shady area, the brightness of the screen will be adjusted so as to display images at the lowest possible brightness level at which the image or video remains clearly visible to detected vehicles. This safety feature may help to avoid a situation where an overly bright screen becomes a distraction to other drivers as the darkness level increases.

In an aspect of the present disclosure, system 200 may be able to determine that the same vehicle(s) are behind vehicle 100 for a progression of stops and starts in traffic. In such an aspect, system 200 can progress through a sequence of advertisements or messages rather than repeating the same advertisements/messages or displaying a random assortment of repeating or non-repeating messages. System 200 may be programmed for the advertisements/messages to be specifically sequenced to hold the interest of drivers and passengers in the following vehicle(s) over a period of time, and to present a purposeful sequence of advertisements/messages rather than random advertisements, which may additionally be location-based advertisements/messages, offering profound advantages to advertisers whose content appears on the screen(s) by allowing them to display more messaging, and more directed messaging, and to avoid repetitive advertisements that might bore or irritate drivers viewing the screen(s).

System 200 can more effectively deliver location-based advertising than currently-available advertising systems. For example, and not by way of limitation, system 200 may determine that vehicle 100, and a vehicle behind vehicle 100, have taken a freeway exit where Restaurant ABC is located. System 200 may display, on display 130, an advertisement for Restaurant ABC, to the vehicle immediately behind vehicle 100, and may then display a progressive sequence of location-based advertising to the following vehicle which can present all of the attractive elements of Restaurant ABC, with each dynamic advertisement playing to its conclusion during each interval when both vehicles are fully stopped. Instead of having one chance to convince the driver of the following vehicle to visit Restaurant ABC, system 200 of the present disclosure provides multiple advertising opportunities, and provides them in a safe manner, because of the proximity of the vehicle stopped behind or beside vehicle 100 and the intelligence of system 200.

Should system 200 determine that the scene behind vehicle 100 changes, or system 200 determines that a new vehicle is now directly behind vehicle 100, system 200 may change the sequence of advertisements/messages for this new scenario of drivers/passengers surrounding the vehicle 100. Should the original vehicle that was following vehicle 100 previously return to the position immediately behind vehicle 100, system 200 may recognize the original vehicle and continue the progression of advertisements/messages curated for that specific vehicle.

Display 130 and/or device 202 can determine a geolocation of system 200/vehicle 100, and may determine that vehicle 100 is approaching a signal-controlled intersection. Display 130 and/or device 202 can also determine the speed of vehicle 100, and may determine that vehicle 100 is decelerating. This may indicate to device 202 that vehicle 100 is about to stop at a red light at the signal-controlled intersection. Using that information the device can predict when the stop will occur and can prepare to transition to display dynamic content at the predicted stop time rather than waiting for a signal for the actual stop time.

If indeed vehicle 100 stops at signal controlled intersection for more than an allotted time, device 202 has enough information to predict that vehicle 100 may be stationary for approximately thirty seconds (or some other amount of time) because vehicle 100 is at a stop light, and the system has stored historical information pertaining to the duration in a time segment (such as seconds) for that particular traffic signal. That predicted stop time can also change as a function of time of day based on historical data analysis. If camera 308 shows a change in scene behind vehicle 100, or shows that there is another vehicle behind vehicle 100, then system 200 has enough information to determine that the vehicle behind vehicle 100 will remain stopped behind vehicle 100 for approximately the same amount of time that vehicle 100 is stopped, and if desired will respond by displaying an advertisement of appropriate duration.

In an alternative version of the invention, a front-facing sensor may determine when the signal light is red, yellow, or green, utilizing this real-time information to predict the stopping or starting of vehicle 100 and any following or adjacent vehicle(s).

In traffic that has variable speeds, e.g., “slow and go” and/or “stop and go” traffic, one or more sensors 230 such as a camera, accelerometer, etc., may determine that the vehicle 100 has come to a stop and/or has reduced speed, and the camera may determine that the scene behind vehicle 100 is not changing and thus the vehicle behind vehicle 100 has stopped. In such a situation, the system 200 may determine whether vehicle 100 has stopped due to traffic on a roadway, or at a stop sign, or is stopped for a longer period of time at a stop light, etc. Such a determination may be made and/or may be assisted by other sensors 230, e.g., the GPS location of vehicle 100, the average recent stopping times of the vehicle, whether the engine has been turned off, whether the mobile device of the user has been removed from vehicle 100, whether a road repair or traffic incident has been reported in the roadway ahead, etc.

For vehicles driving in stop and go traffic, system 200 may incorporate artificial intelligence components and algorithms to predict the likely stopping time of vehicle 100. Sensors will record the average stopping time of vehicle 100's most recent stops, and make an assessment of probable future stopping times in light of the average duration of past stops and various other pertinent factors, including the current speed and acceleration or deceleration of vehicle 100, the GPS location of vehicle 100 relative to any factors which might impact stopping times (e.g., a change in roadway characteristics ahead), and other characteristics of the surrounding environment of vehicle 100 as determined by the various sensors of system 200. Having estimated the probable next stopping time of vehicle 100, system 200 is then empowered to select a video advertisement or entertainment to display once vehicle 100 has stopped that will be of an appropriate duration to allow the video to conclude before vehicle 100 resumes motion. In so doing, system 200 will create substantial value for advertisers in making it probable that video advertisements displayed on the screen(s) are not interrupted before they conclude. Advertisements which do not reach their conclusion (e.g., a thirty second dynamic video that only displays for 20 seconds) may not be effective in promoting the intended products or services to the occupants of surrounding vehicles, and advertisers may not wish to pay for such interrupted advertisements, or may ask to pay a lesser amount. Furthermore, the occupants of any vehicles adjacent to vehicle 100 would likely not enjoy the experience of seeing only part of each video advertisement or entertainment displayed, when most such videos are produced and intended to be seen in their entirety. By predicting the length of the stop in advance of displaying dynamic content, the system increases the likelihood that the dynamic content will be viewed in its entirety.

Driver/operator of vehicle 100 may not be shown the videos playing on the screen(s), and may not be aware when a video has started or stopped; thus reducing driver distraction and reducing the possibility that a driver will stop longer than necessary in order to increase driver remuneration. Although it remains possible that the driver of vehicle 100 may stop for longer than necessary in certain situations in order to earn additional income, other sensors 230 may be employed to reduce and/or prevent such additional remunerations from occurring. For example, and not by way of limitation, other sensors 230 may be attached to other portions of vehicle 100, e.g., the front of vehicle 100, in order to sense the behavior of other vehicles, traffic signals or other objects or conditions in front of vehicle 100, to determine whether vehicle 100 has remained stopped longer than necessary to reduce the incentive to stop longer than necessary. Other techniques, e.g., GPS positioning of vehicle 100, etc., may also be used to determine appropriate stopping times for vehicle 100 as desired. Such indications of excessive stoppage time of vehicle 100 may also be displayed to the driver of vehicle 100 to indicate that the driver is not earning additional money during such times.

System 200 may also take into account other events, e.g., geolocation, traffic conditions, changes in the scene detected by camera 308, etc., to help determine what advertisements to show on display 130 and/or when to change advertisements on display 130. The scene detected by camera 308 can be, for example, a detected vehicle or a change in detected vehicle (e.g., different detected vehicle). Such indicators may contribute to increasing safety conditions by predicting the upcoming need for increased driver attention and not playing longer, more dynamic and/or specific advertisements, or any advertisements in general, while vehicle 100 is moving or when upcoming conditions might necessitate more driver attention for reasons of safety.

Camera 308 may also be able to determine the type of vehicle that is stopped behind vehicle 100. Camera 308 may be able to detect a grille pattern, brand badge, vehicle shape, license plate, or other indicators to determine the type of vehicle that is stopped behind vehicle 100. Camera 308 may also be able to determine whether there is a passenger in the vehicle(s) stopped behind vehicle 100, the number of passengers, whether the passengers are adults or children, and other information. In an aspect of the present disclosure, the characteristics of the vehicle 100 and the surrounding vehicles near vehicle 100 provide a dynamic environment in which system 200 may display targeted advertisements within the driver/passenger field of view. System 200 may differentiate between vehicles and the statistical demographics of owners of such vehicles, and provide different advertisements to different vehicles based on the type of vehicle that is identified by system 200 and the driving conditions that vehicle 100 is experiencing. By taking various indicators into account, system 200 may target a specific advertisement and/or set of advertisements on display 130 towards the vehicle stopped behind vehicle 100. For example, if a Toyota brand vehicle is positioned within view of the display, an advertisement for a Toyota repair service may display. If a specific year vehicle, such as a 2007 Toyota Prius is detected, then an advertisement for a repair might be shown or an advertisement for a new vehicle. Historical responses of specific drivers or drivers in general to various advertising may be used to predict driver receptivity to advertising and determine the type of advertising displayed. For example, if a specific driver of a Toyota brand vehicle has failed to respond in a measurable way when shown an advertisement for Toyota in the past, then the driver might instead be shown an advertisement for a Mazda vehicle the next time that he or she is shown an advertisement on the display. Alternatively, if only 10% of Toyota drivers shown Toyota advertisements on the display historically have responded in a measurable way, the system might instead display an advertisement for Mercedes to those drivers of Toyotas. Whereas if 60% of Mazda drivers shown a Mazda advertisement on the display historically have responded in a measurable way indicating potential interest in the future purchase of a Mazda vehicle, then the system might display an advertisement for Mazda to those drivers of Mazdas. In another example, the new vehicle advertisement can also take into account brand loyalty of the typical driver of that vehicle. Thus, Toyota has a brand loyalty of 62% which suggests showing a Toyota ad would be appropriate. In contrast, if a vehicle has a brand loyalty less than 50% showing an ad for a similar type of car (sedan, SUV) of another brand may be more appropriate.

Where children are detected in an adjacent vehicle, the system can estimate age and take into account time of day to make specific advertisements available, such as toys, childrens' clothing, childcare, family restaurants or entertainment; or may display forms of sponsored entertainment such as animated videos without explicit advertising content.

In an aspect of the present disclosure, the sensors of system 200 may assess and identify surrounding vehicles using anonymous identification technology. Sensors and cameras of the system 200 are configurable to identify surrounding vehicles and/or passenger details for the purpose of providing a better advertising or entertainment experience. However, some might consider the collection of such information to be an intrusion of privacy. Accordingly, anonymization identification programs and filters may be employed to assure that any personal information about the adjacent vehicles and their owners or occupants will not be retained or transferred to other parties. Such anonymous identification technology might include both the ability to limit what information is collected and the ability to delete and/or not retain personal information which might be collected in the course of vehicle scanning and identification. In one illustrative example, when the license plate of an adjacent vehicle is scanned for the purpose of vehicle identification and recognition, only a portion of the license plate characters (numbers and letters) might be saved in an integrated memory of system 200, with a minimum of one character being deleted from every saved license plate number. While the scanning and saving of license plate numbers is now commonplace throughout the world, in the minds of many individuals this might represent a substantial privacy intrusion. The privacy features of this and other anonymous identification technology may make the practice of license plate scanning, facial recognition, and other data collection far less objectionable to the average person from the standpoint of privacy; and may provide comfort to the owners and drivers of vehicles viewing images on the screen(s) which will make these individuals more receptive to the advertising, data, messages and entertainment presented. Furthermore, this anonymous identification technology has broad applications beyond that pertaining to the Predictive Advertising Systems and Methods described herein, and may have broad utility in many industries and applications that involve the scanning, filming or otherwise collecting personal characteristics, details, information, or images for various uses.

When approaching an exit on a highway or freeway, sensors in a vehicle 100 might show that a vehicle following the vehicle 100 has activated its turn indicator, indicating an intent to exit the freeway. System 200 can be configured to respond to the detection of a turn indicator in a vehicle by displaying an advertisement for a commercial establishment, such as a restaurant located proximate to the exit detected by the GPS sensor, based on that vehicle's predicted exit from the freeway. In another example, when approaching an intersection, sensors in a vehicle 100 might determine that the following vehicle has two passengers in business attire driving a sedan at a time of day approaching a meal time, such as lunch. The system 200 can be configured to respond to the identification of the vehicle type and passenger information by displaying a lunch special for a restaurant located ahead. Additionally, the acquired information can be analyzed in conjunction with historic information to provide a prediction of next action. Such determinations may be made, for example, in an application and/or program associated with or in communication with display 130 and/or device 202.

Historical data may further refine recommendations. For example, historical data might show that 60% of the vehicles that stop at a red traffic signal situated in front of Restaurant A will visit Restaurant A if shown an advertisement relating to Restaurant A while stopped at the red traffic signal. The historical data can further be refined by the time of day, e.g., likelihood of stopping when the time of the stop approaches a typical mealtime. Based on this historical data, a prediction of a driver's next action determines that dynamic advertising content relating to Restaurant A will be featured on the display when vehicle 100 is stopped at this traffic signal with another vehicle stopped behind it.

Camera 308, although shown as part of display 130, may be a backup camera that is part of vehicle 100. As such, signals 226 may include the inputs from camera 308, and these signals can be routed to device 202 as needed to determine the various characteristics of the scene behind vehicle 100. The display 130 may also be combined with a built-in backup camera of vehicle 100, which may reduce the overall costs of system 200 and may reduce and/or eliminate the inclusion of camera 308 in system 200.

In addition to various forms of advertising, system 200 may be used to display messaging which can be initiated by either the driver of vehicle 100, the supplier of system 200, the supplier's affiliated entities, and/or other parties. These messages might be simple communications such as “Hello!” or “Smile!” or social or political statements such as “Don't Pollute!” or “Vote Lincoln!”, jokes or riddles, or practical commands (for drivers who know one another) such as: “Need Gas!” Or drivers might be permitted to display, in just one example, the logo of their favorite sports team. Such access to system 200 may be limited to certain times or a certain number of times during a given time period. An application for a mobile device used as an integrated component of system 200, and/or system 200, may include “hands free” functions for an operator/driver sending user-generated messages to the display screen in order to augment safety, including but not limited to a variety of pre-composed messages which the operator/driver may select and send to the display screen using verbal commands only. Various optional “hands free” functions might include, for example, and not by way of limitation, allowing the driver of vehicle 100 to request that the driver of a following vehicle flash the following vehicle's headlights lights one time, or to activate the vehicle's windshield wipers, if the answer to a question posed by the driver is “yes.” Content that requests a driver of an adjacent vehicle to respond, e.g., by flashing lights, can be inquiry media because the content is essentially making an inquiry of the adjacent vehicle.

User-generated messages inputted by the operator/driver may require approval by a system administrator, and may be uploaded from the mobile device of the operator/driver to a server for this purpose before display on the screen is permitted. Other restrictions of user-generated messages may include the driver being prevented from submitting messages while vehicle 100 is in motion, for safety reasons; or may include the user-generated messages being allowed to appear only when the vehicle is moving, or not moving, if any such scenario is reserved exclusively for paid video advertisements or other content. System 200 may also require the operator/driver of vehicle 100 to submit a payment or service in exchange for displaying a message, which might be deducted automatically from the compensation provided to an operator/driver. In another embodiment, the display 130 may show a message from an advertiser and include a corporate logo or product name.

System 200 may also display internet addresses, also known as Uniform Resource Locators (URLs), or Quick Response (QR) codes which may be used by the surrounding drivers to access information, discounts, discount codes, and/or special rewards. For example, and not by way of limitation, display 130 of system 200 may display the message “FREE LUNCH,” along with an internet URL (e.g.,—www.RestaurantABC.com/lunch) that the drivers/passengers must access in order to obtain more information about the free lunch. By using the inputs from vehicle 100/system 200 to associate the offer with those that accept the offer, advertisers may provide enhanced, restricted or otherwise customized discounts, merchandise, etc. that is being offered and receive fairly quick feedback on the effectiveness of such advertising campaigns. In an aspect of the present disclosure, internet URL addresses and/or QR codes may only be displayed when the vehicle 100 and/or other vehicles around vehicle 100 are stopped, to enhance driver safety; or may only be displayed when more than one passenger is detected in the vehicle(s) behind or beside vehicle 100, or when certain models of vehicle(s) are detected, and so on.

Where passengers interact with a QR code or URL link or other interactive link or technology displayed on system 200, the passengers of the vehicle behind vehicle 100 might be allowed to exert control over what advertising or messaging they are viewing, and/or to hear audio content associated with the videos or images displayed on the screen, either through their mobile devices, or through a radio band, or through devices such as speakers or earphones connected to Bluetooth or other wireless transmission technology, or other methods. For example, and not by way of limitation, after scanning the QR code, surrounding vehicle(s) might be able to choose what types of restaurant discounts they are offered by system 200, e.g., fast food or upscale dining, etc. Further, the passengers of a following vehicle might be encouraged by a message, code, or URL on display 130 of system 200 to reference various forms of social media, message the driver of vehicle 100, or other interactive messaging such as obtaining real and/or virtual rewards. In such an aspect, special “Bonus Items” might be advertised on the system 200, which might in one example offer the opportunity for both the driver and passengers of vehicle 100 and occupants of the following vehicle to mutually benefit from a purchase. For example, an advertisement for a hamburger available at an upcoming exit might offer bonus compensation to the drivers of both vehicles if both drivers stop at the restaurant.

System 200 may also be used to record various scenarios that may be important for the driver of vehicle 100 above and beyond the functions of a backup camera. Camera 308, for example, may record the scene behind or beside or in front of vehicle 100 during vehicle 100 motion, and should a traffic accident occur, e.g., when another vehicle impacts the rear-end or side or front of the vehicle 100, system 200 may provide the driver of vehicle 100 with evidence of the event.

### System Connection to Vehicle

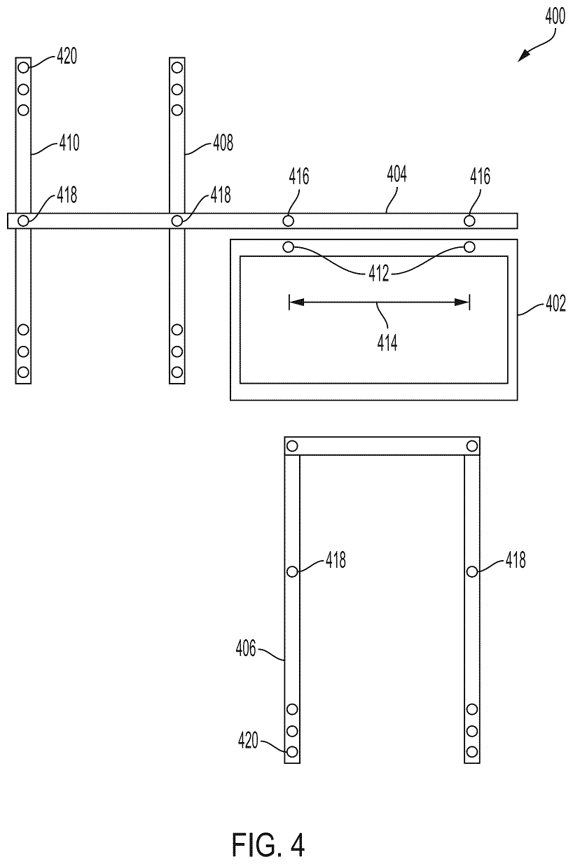

FIG. 4 illustrates a mounting device in accordance with an aspect of the present disclosure. Mounting device 400 may comprise a frame 402, horizontal member 404, vertical member 406, and display members 408 and 410. Frame 402 has mounting holes 412 spaced at a distance 414. Distance 414 may be a standard distance for license plates 120 that are attached to vehicles 100.

Frame 402 may be a part of mounting device 400, or may be a separate frame 402 that is provided by the owner/driver of vehicle 100. Frame 402 may be a “personalized” frame, in that frame 402 may be a frame that states “alumni” or a personal message related to the owner and/or vehicle 100.

Horizontal member 404 has mounting holes 416 or apertures that allow horizontal member 404 to attach to frame 402 via mounting holes 412. Although shown pointing left, horizontal member 404 may face to the right if desired. Horizontal member 404 also has mounting holes 418 that allow horizontal member 404 to mount to display members 408 and 410.

Vertical member 406 has mounting holes 416 or apertures similar to those of horizontal member 404, which mounting holes 416 or apertures allow vertical member 406 to attach to frame 402 via mounting holes 412. Although shown pointing down, vertical member 406 may face or point up if desired. Vertical member 406 also has mounting holes 418 that allow vertical member 406 to mount to display members 408 and 410.

Display members 408 and 410 have mounting holes 420 that allow for display members 408 and 410 to couple to display 130.

Display 130 may vary in size, and may require a number of mounting holes 420. For example, and not by way of limitation, display 130 may be a 14 inch diagonal screen, or a long narrow “banner” type screen e.g., 8″ high by 48″ long. Different display 130 sizes are possible within the scope of the present disclosure.

Mounting device 400 may be of a “quick release” nature, allowing display 130 to be coupled and/or uncoupled with relative ease. For example, and not by way of limitation, the mounting hardware for use in mounting holes 420 may be of a snap-lock type, while the remainder of the mounting hardware may be screws, rivets, etc. Further, mounting device 400 may include a locking mechanism to deter unauthorized removal of display 130. Additional protections against unauthorized removal may also be included, e.g., a GPS tracker in display 130, etc.

Mounting device 400 may also include other supporting mounts to stabilize display 130 and/or reduce incidental movement of display 130 when vehicle is in motion. Further, other types of mounting devices 400, e.g., suction cups, magnets, tic-downs, or other means may also be used, in conjunction with and/or instead of mounting device 400, without departing from the scope of the present disclosure. Alternative or additional mounting devices 400 may also mount to other portions of vehicle 100, e.g., mounting to a trailer hitch, hanging from a trunk or other part of vehicle 100 with straps, hooks, suction cups, rigid or semi rigid brackets or extensions, and/or other means.

For rear-mounted screen, video screen hardware might allow for easy attachment to license plate mount or tow hitch mount, and easy relocation of license plate if necessary to a location above, below, or to the side of the video screen via a license plate mount on the screen casing, along with an integrated light fixture to illuminate the license plate at night, powered by the electrical power source of the video screen, or other power source.

In another configuration, the rear side of the video screen may be composed of magnetic material which allows for effortless attachment to vehicle 100; and the driver may have the option of removing the screen and leaving it inside vehicle 100 each time that the car is parked and left attended.

### System Usage, Tracking and Compensation

In an aspect of the present disclosure, system 200, which may include software and/or use of applications on a cellular telephone or other device, may track the advertisements, etc., and associated times of display of the advertisements, that are displayed on display 130. The times, advertisements, types of advertisements, number and duration of advertisements displayed in full or displayed only in part, time stopped, time moving, etc., may then be used to determine a compensation for the driver of vehicle 100. System 200 may provide the driver with real-time information about the money that the driver has earned based on the display of advertising, data, entertainment, messaging and/or other content on the screen(s). Compensation formulas may be introduced which dictate that the driver will earn more money when driving in heavy traffic, when vehicle 100 is more often stopped and more often displaying videos. Such rapid or real-time feedback about earnings rates and amounts will serve as an encouragement for drivers to operate their vehicle with a display screen featuring the system 200. Furthermore, the mobile device application may allow the driver of vehicle 100 to request payment of money earned, or to make purchases of goods or services using the money earned. Depending on the types of advertisement that are displayed by a given system 200, different amounts of compensation may be paid. For example, if only short, “static” advertisements are displayed, a first tier of compensation may be paid; however, if longer, more detailed advertisements, or sequence of advertisements are displayed (e.g., when vehicle 100 is in heavy traffic and a captive audience may be available), a different tier of payment may be awarded to the driver of vehicle 100. Many different algorithms and determinations of compensation may be employed without departing from the scope of the present disclosure. Further, by only displaying dynamic advertisements when vehicle 100 and any surrounding vehicle(s) are fully stopped, and by offering higher compensation to the driver of vehicle 100 when dynamic advertising is displayed to its completion, the invention provides a unique earning opportunity for drivers. Typically, taxi and rideshare drivers tend to earn less money when they are delayed by heavy traffic, whether or not they are actively transporting passengers. But with system 200, such drivers can earn more income when driving in heavy traffic than when not driving in heavy traffic.

As an example, and not by way of limitation, an application can record the GPS data from the driver's mobile device (and/or the GPS data of vehicle 100 and/or the GPS data of device 202) to track the routes traveled by vehicle 100. The application can also record the number of times and duration of times that a static or dynamic advertisement or message is displayed on display 130, and whether a dynamic advertisement played to its completion or was interrupted due to vehicle motion, and can record the scenes surrounding the vehicle 100 during travel times. These and other data points can be used to construct a payment algorithm that determines the compensation paid to the driver/operator of vehicle 100. The payment can be displayed on the application such that the driver/operator of vehicle 100 can be informed regarding the compensation due.

System 200 can also supply such information, e.g., camera 308 information, vehicle 100 geolocation, etc., to advertisers such that the times, locations, etc. of a particular advertisement are known and the effectiveness of such advertisements can be better determined. For example, an advertiser can be given data on: (1) the exact length of time that a particular vehicle was exposed to an advertisement; (2) whether the advertisement was displayed in daytime or nighttime; (3) whether there were passengers in the vehicle to which the ad was displayed; (4) how long it took an individual to respond to an ad; (5) whether a dynamic advertisement played to its completion or was interrupted due to vehicle motion; (6) vehicle 100's exact location at the time that an advertisement was displayed; and/or myriad other data, allowing advertising strategies to be developed and fine-tuned.

System 200 can alternatively supply such information directly or indirectly to municipalities or other entities which might regulate or impose taxes on the income derived from the advertising displayed by vehicle 100 within specific fiscal or regulatory zones. The supply of such information might include, but not be limited to, a “geo-fenced” zone being created with GPS coordinates corresponding to the geographical boundaries of a given municipality or other geographical zone, allowing system 200 to calculate the precise number of advertisements of varying types that are displayed within a given time period within that given municipality; allowing the municipality to optionally utilize this information for regulatory, taxation, or other purposes. Such information might optionally be transferred wirelessly directly to the municipality or other authority or organization in real time by system 200 rather being transferred at a later time by the owner of system 200. Alternatively, the fees or taxes payable to a municipality or other authority or organization may be calculated in real time by system 200 based on data including but not limited to the number of advertisements or other media displayed in a given time period in a given geo-fenced zone.

Further, system 200 may allow for user generated advertising to be shown on display 130. Because a driver of vehicle 100 knows ahead of time that he/she will be driving to work, and he/she knows the route to be traveled, that user may create a unique advertising sequence during their drive time, as such a driver would know what shops are on their chosen route. As such, drivers can create their own advertising scheme if they think it is likely to generate more interest. For example, a truck driver who frequents a diner that caters to truck drivers might suggest an ad offering “Free Coffee for Truck Drivers.” The driver may then have an option to submit photo(s) and/or video(s) which would be incorporated into the ad.

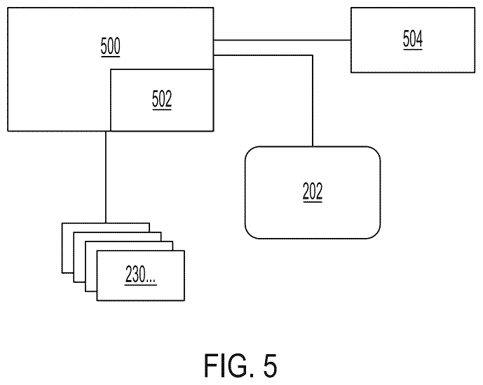

FIG. 5 illustrates a controller in accordance with an aspect of the present disclosure. System 200 can include a controller or other processing unit, such as a microcontroller 500, shown schematically in FIG. 5. The microcontroller 500 may include an internal memory 502 and/or external memory 504 and can serve many different functions. For example, in one embodiment, the microcontroller 500 may serve to regulate the power provided to system 200, control the system 200 through readings from sensor(s) 230 and/or other sensors within the system 200, accept input from the device 202, or other controlling and/or monitoring functions. Many different functions are possible without departing from the scope of the present disclosure.

The memory, which may be internal memory 502 or external memory 504 to microcontroller 500, may be implemented in firmware and/or software implementation. The firmware and/or software implementation methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit (e.g., microcontroller 500). Memory may be implemented within the processor unit or external to the processor unit. As used herein, the term “memory” refers to types of long term, short term, volatile, nonvolatile, and/or other non-transitory memory and is not to be limited to a particular type of memory or number of memories, or type of media upon which memory is stored.

If implemented in firmware and/or software, and/or as part of microcontroller 500 and/or memory 502/504, the functions described herein may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer (e.g., microcontroller 500); disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors (e.g., microcontroller 500) to implement the functions outlined.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

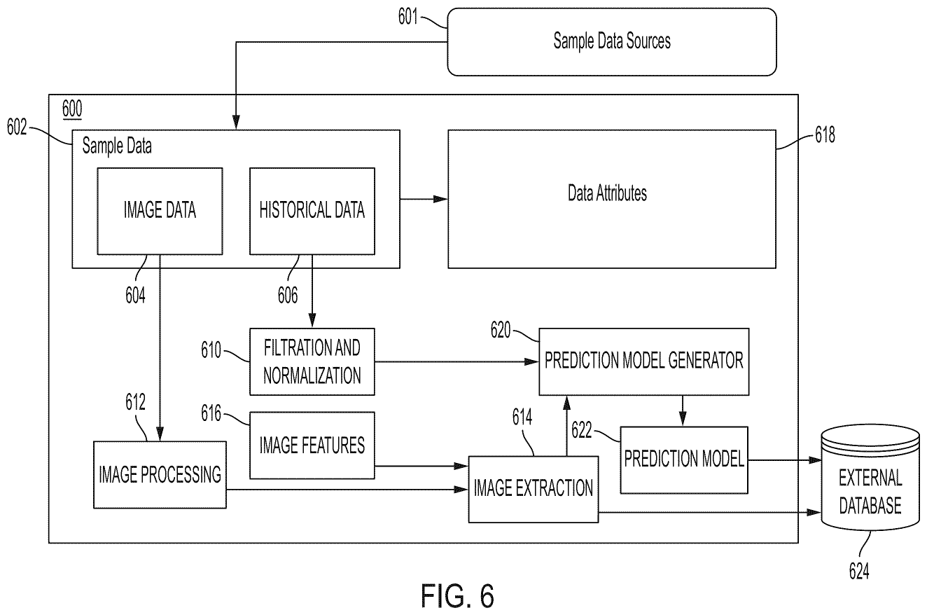

FIG. 6 is a block diagram that illustrates and exemplary scenario for generating a predictor model in accordance with the disclosure. After the generation of the predictor models, the application server may be configured to utilize the predictor models during a prediction phase to predict outcomes based on various inputs received from the system (e.g., received target data). The outcomes may include, for example, predicting behavior of the transportation devices, including whether the surrounding vehicles will soon be fully stopped or are currently fully stopped and are likely to remain stopped for a period of time, and if so, the predicted length of time that they will remain fully stopped. Additionally, the systems are configurable to predict an optimal advertising or entertainment content based on sensed information, time and location information, prompted driver actions or responses, reports of proximate traffic accidents or weather or other factors potentially impacting vehicle 100 and any surrounding vehicles at some future time, information about the historical tendencies or behavior of a specific driver or vehicle, and public information about drivers and consumers generally. The prediction module may include suitable logic, circuitry, interfaces, and/or code, executable by the circuitry, that may be configured to implement the prediction phase for predicting the business outcomes by using the collected data and/or target data as input to the predictor models. In one embodiment, the prediction module may be configured to use the predictor models to predict behavior of the vehicles, including whether the surrounding vehicles are fully stopped, and if so, the predicted length of time that they will remain fully stopped based on the analyzed historical data and extracted values from the display input data. The model generator may be configured to use one or more machine learning algorithms, such as regression based predictive learning, neural networks based predictive leaning, and the like, for generating predictor models. During the generation of the predictor models, the model generator may be configured to map the features and analyzed historical data with the derived attributes based on the extracted feature values and generate links therebetween. The prediction module may be operable to query a database server to retrieve the predictor model. The predictor module may use extracted values from the data to yield predictions.

A sample data source 601 is provided. The sample data source 601 includes information about vehicles, vehicle drivers, typical income and/or preferences of vehicle drivers and other information. Additional data sources can include information about a geographic location including road conditions (real-time and/or historic), weather (real-time and/or historic), merchants and merchant bibliographic information (including hours of operation). The sample data source 601 is provided to the sample data 602 of the scenario 600. The sample data 602 includes image data 604 and historical data 606. The historical data 606 includes a plurality of data attributes 618. Historical data can be filtered and normalized in the normalization module 610 and then provided to a prediction model generator 620. Image data 604 is image processed 612. Image processing extracts information from the image 614 and then delivers the extracted data to an external database 624. The image has image features 616.

After retrieving the sample data 602, the application server may be configured to process the sample data 602. Processing of the sample data 602 may involve filtering and normalizing the historical data 606. Thus, the filtration and normalization module 610 may be configured to filter out and normalize the historical data 606 so that only relevant information is processed further. Processing of the sample data 602 may further involve analyzing the image data 604. For analyzing each image in the image data 604, the feature extraction module may be configured to perform image processing followed by feature value extraction. Before analyzing the image data 604, the feature extraction module may be configured to query the external database server to identify images from the image data 604 that are already analyzed by the feature extraction module. Referring to prior analyzed images can facilitate quicker analysis and focusing on changes to the images. The application server may be configured to perform image processing and feature value extraction in a chronological order based on the date and time markers of the received images from a vehicle

The predictor models 622 generated by the model generator. A first predictor model may be capable of predicting interests of an adjacent vehicle based on time of day, location, driver gender, driver estimated age, vehicle type, vehicle color, vehicle year, etc., as input. For example, the first predictor model may be capable of predicting a target restaurant based on time of day and vehicle.

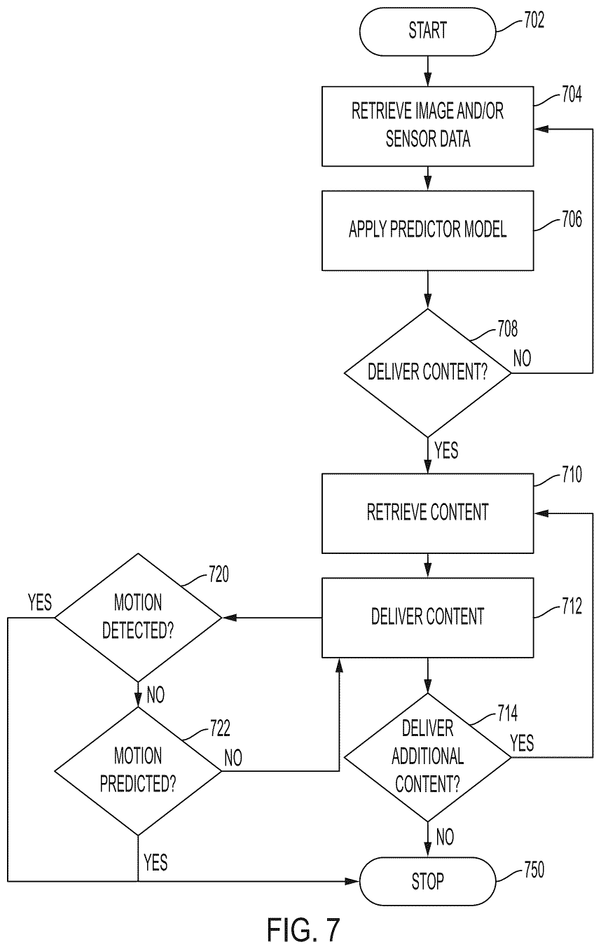

FIG. 7 is a flow chart that illustrates a method for delivering predicted content. The process starts 702 with retrieving one or more of image and/or sensor data 704. The image can be an image and/or video from the device in a first vehicle and the sensor data can be, for example, GPS location data, weather data, etc. The retrieved data is then provided to a predictor model 706. The predictor model 706 evaluates the one or more pieces of retrieved data and makes a decision about delivering content 708. If no content is delivered (NO), then the system continues to retrieve and evaluate data in a loop until a decision is made to deliver content (YES). Once the decision is made to deliver content, such as when the vehicle is stopped or is predicted to stop, content is retrieved 710 and then delivered 712. A sub process can be performed to decide which content is to be delivered based on the analyzed data and the type of content available for delivery. If motion is detected 720 (YES), then the content delivery stops at the process stop 750 step. If motion is not detected (NO), then the model determines whether motion is predicted 722. If motion is predicted (YES), then the content delivery stops. If motion is not predicted (NO), then content continues to be delivered 712. Once content has been delivered, the system determines whether to deliver additional content 714. If additional content is to be delivered then additional content is retrieved 710. If no additional content gets delivered, then the process stops 750. Delivering content can include delivering, for example, video and/or changing images or graphics, and combinations thereof. When content is not actively delivered, a static image can be provided. The static image can include content, but is not dynamically presented.

The present teachings may also extend to one or more of the following numbered clauses:

Clause 1: A mobile advertising system comprising: a first device; one or more cameras in communication with the first device, wherein the one or more cameras are operable to capture and transmit a scene for analysis to the user device; one or more mountable second device wherein each of the one or more mountable second device includes a display device; and a non-transitory computer readable medium having computer readable instructions thereon that, when executed by a computer, cause the computer to execute operations comprising analyze one or more of a physical characteristic of a detected scene captured from at least one of the each of the one or more cameras, a behavior of a detected vehicle in the detected scene from at least one of the each of the one or more cameras, and a number of occupants in the detected vehicle, retrieve an historical data based on one or more of a GPS location, a date, a day of week, a time, a vehicle type, an occupant type, and an occupant number, analyze the retrieved historical data, generate a prediction based on the analyzed physical characteristics of the detected scene and the analyzed retrieved historical data, select a media based on the prediction, deliver the media to the display device, and display a received media on at least one of the display device, wherein the first device and the second device are located in a system transporting vehicle.

Clause 2: The mobile advertising system of clause 1 wherein the media is a video segment or an image.

Clause 3: The mobile advertising system of clause 1 further comprising detect a presence of an adjacent vehicle; and display the received media when at least one adjacent vehicle is detected.

Clause 4: The mobile advertising system of clause 2 wherein a length of the video segment is based at least in part on the generated prediction.

Clause 5: The mobile advertising system of clause 1 further comprising a second device having one or more second device cameras in communication with the second device, wherein the one or more second device cameras are operable to capture and transmit a second device scene for analysis to the first device, wherein the second device camera faces a rear of a system transporting vehicle, such that a detected vehicle with the second device can view an image shown via the display device.

Clause 6: The mobile advertising system of clause 1 wherein a duration of a display time is based on a prediction.

Clause 7: The mobile advertising system of clause 1 wherein the received media comprises one or more of a quick response (QR) code, a uniform resource locator (URL), and a discount code.

Clause 8: The mobile advertising system of clause 1 wherein a remuneration is associated with each media.

Clause 9: The mobile advertising system of clause 1 wherein a remuneration correlates to a detected stop time.

Clause 10: The mobile advertising system of clause 1 wherein a media is pre-programmed into the first device to be shown on the display device.

Clause 11: The mobile advertising system of clause 1 wherein the received media is a progressive sequence of location-based advertising.

Clause 12: The mobile advertising system of clause 1 wherein the received media is not repeated when the same vehicle is detected.

Clause 13: The mobile advertising system of clause 1 further comprising a privacy and safety function that limits visibility of the received media when a viewing angle of a viewer is not within a target range.

Clause 14: The mobile advertising system of clause 1 further comprising a panic feature operable to communicate information including a distress signal and GPS coordinates to a third party.

Clause 15: The mobile advertising system of clause 1 further wherein the delivery of the received media is interrupted to provide a safety message in response to a detected parameter.

Clause 16: The mobile advertising system of clause 1 wherein the received media is based on at least one of a GPS location, a brand of a detected vehicle, a make of the detected vehicle, a model of the detected vehicle, a presence of a passenger in the detected vehicle, a number of passengers in the detected vehicle, a license plate of the detected vehicle, and one or more businesses proximate to the GPS location of the first device.

Clause 17: The mobile advertising system of clause 1 wherein the received media displayed changes when a sensor indicates a different detected vehicle is facing the screen.

Clause 18: The mobile advertising system of clause 1 wherein the mobile advertising system determines whether a detected vehicle has been previously sensed and displays a media not previously displayed for a detected vehicle.

Clause 19: The mobile advertising system of clause 1 further comprising a projection system configurable to project an image.

Clause 20: The mobile advertising system of clause 19 wherein the image is a holographic image.

Clause 21: The mobile advertising system of clause 1 wherein the mobile advertising system is powered by a dual function including a restricted circuit battery system to facilitate media display when a vehicle engine is not running and one or more supplemental batteries are provided to power the system when the vehicle engine is not running.

Clause 22: The mobile advertising system of clause 1 wherein the mobile advertising system generates a report including two or more of duration, time of day, type of media presented, type of vehicle receiving the media presented, and response to media.

Clause 23: The mobile advertising system of clause 1 wherein the mobile advertising system is configured to receive an input message from the first device for display on the display device.

Clause 24: The mobile advertising system of clause 1 wherein the mobile advertising system is configured to receive an instruction from the first device wherein the instruction is based on a detected verbal instruction.

Clause 25: The mobile advertising system of clause 1 wherein received media pertaining to at least one of a number of advertisements and a type of advertisements displayed in a time period is geo-fenced.

Clause 26: The mobile advertising system of clause 1 wherein the data pertaining to at least one of a number of advertisements and a type of advertisements displayed is at least one of recorded by the mobile advertising system and transmitted by the mobile advertising system.

Clause 27: A non-transitory computer readable medium having stored thereon, computer executable instructions, which when executed by a computer, cause the computer to execute operations, the operations comprising: analyze one or more of a physical characteristic of a detected scene captured from a camera, a behavior of a detected vehicle in the detected scene, and a number of occupants in the detected vehicle, retrieve historical data based on one or more of a GPS location, a date, a day of week, a time, a vehicle type, an occupant type, and a vehicle occupant number, analyze the retrieved historical data, generate a prediction based on an analyzed physical characteristics of the detected scene and the analyzed retrieved historical data, select a media based the generated prediction, and deliver the media to a display device.

Clause 28: The non-transitory computer readable medium of clause 27 further comprising select at least one of a static media and a dynamic media based on the generated prediction.

Clause 29: The non-transitory computer readable medium of clause 27 wherein the media delivered is a progressive sequence of location-based advertising.

Clause 30: A mobile advertising system comprising: a first device; at least one camera in communication with the first device, wherein the at least one camera is operable to capture and transmit a scene for analysis to the user device; at least one mountable second device comprising a display device; at least one GPS sensor; at least one non-transitory computer readable medium having computer readable instructions thereon that, when executed by a computer, cause the computer to execute operations comprising analyze one or more of a physical characteristic of a detected scene captured from the camera, generate an inquiry media with a response activity for display on the display device; detect whether a response activity has been received, if a response activity is received, select a media for delivery based on the response activity, and if no response activity is received, select a generate a new inquiry with a response activity for display on the display device.

Clause 31: The mobile advertising system of clause 30 further comprising a sensor, wherein the at least one camera, the sensor and the display faces a rear of a system transporting vehicle, such that a detected vehicle behind the system transporting vehicle can view an image shown via the display device.

Clause 32: The mobile advertising system of clause 30 wherein a received media comprises one or more of a quick response (QR) code, a uniform resource locator (URL), and a discount code.

Clause 33: The mobile advertising system of clause 30 wherein a remuneration is associated with each media.

Clause 34: The mobile advertising system of clause 302 wherein a media is pre-programmed into the first device to be shown on the display device.

Clause 35: The mobile advertising system of clause 30 wherein the media is not repeated when the same detected vehicle is detected.

Clause 36: The mobile advertising system of clause 30 further comprising a privacy function that limits visibility of an inquiry media when a viewing angle of a viewer is not within a target range.

Clause 37: The mobile advertising system of clause 30 further comprising a panic feature operable to communicate with a third party.

Clause 38: The mobile advertising system of clause 30 further wherein a delivery of the inquiry media is interrupted to provide a safety message in response to a detected parameter.

Clause 39: The mobile advertising system of clause 30 wherein a received media is based on at least one of a GPS location of a system transporting vehicle, a brand of a detected vehicle, a make of the detected vehicle, a model of the detected vehicle, a presence of a passenger in the detected vehicle, a number of passengers in the detected vehicle, a license plate of the detected vehicle, and one or more businesses proximate to the GPS location of the first device.

Clause 40: The mobile advertising system of clause 30 wherein a received media that is displayed changes when a sensor indicates a new detected vehicle is facing the screen.

Clause 41: The mobile advertising system of clause 30 wherein the mobile advertisement system determines whether a detected vehicle has been previously sensed and displays a media not previously displayed for the detected vehicle.

Clause 42: The mobile advertising system of clause 30 further comprising a projection system configurable to project an image.

Clause 43: The mobile advertising system of clause 42 wherein the image is a holographic image.

Clause 44: The mobile advertising system of clause 30 wherein the mobile advertisement system generates a report including two or more of duration, time of day, type of media presented, type of vehicle receiving the media presented, and response to media.

Clause 45: The mobile advertising system of clause 30 wherein the mobile advertisement system is configured to receive an input message from the first device for display on the display device.

Clause 46: The mobile advertising system of clause 30 wherein a received media is a progressive sequence of location-based advertising.

Clause 47: A display device comprising: a housing; and a screen operable to display a media content; a non-transitory computer readable medium having computer readable instructions thereon that, when executed by a computer, cause the computer to execute operations comprising analyze one or more of a physical characteristic of a detected scene captured from the camera, a behavior of a detected vehicle in the detected scene, and a number of occupants in the detected vehicle, retrieve historical data based on one or more of a GPS location, a date, a day of week, a time, a vehicle type, an occupant type, and an occupant number, analyze the retrieved historical data, generate a prediction based on the analyzed physical characteristics of the detected scene and the analyzed retrieved historical data, select a media based on the prediction, deliver the media to the display device, and display a received media on the display device.

Clause 48: The display device of clause 47 wherein the received media is a video segment or an image.

Clause 49: The display device of clause 47 wherein a length of the video segment is based at least in part on the generated prediction.

Clause 50: The display device of clause 47 wherein the display device is in communication with a camera and a sensor and the screen faces a rear of a transporting vehicle, such that a detected vehicle behind the transporting vehicle can view an image shown via the screen.

Clause 51: The display device of clause 47 wherein the received media comprises one or more of a quick response (QR) code, a uniform resource locator (URL), and a discount code.

Clause 52: The display device of clause 47 wherein a remuneration is associated with each media.

Clause 53: The display device of clause 47 wherein a media is pre-programmed into the display device.

Clause 54: The display device of clause 47 wherein the received media is a progressive sequence of location-based advertising.

Clause 55: The display device of clause 54 wherein the received media is not repeated when the same detected vehicle is detected.

Clause 56: The display device of clause 47 further comprising a privacy function that limits visibility of the received media when a viewing angle of a viewer is not within a target range.

Clause 57: The display device of clause 47 further comprising a panic feature operable to communicate with a third party.

Clause 58: The display device of clause 47 further wherein the delivery of the received media is interrupted to provide a safety message in response to a detected parameter.

Clause 59: The display device of clause 47 wherein the received media is based on at least one of the GPS location of a transporting vehicle, a brand of a detected vehicle, a make of the detected vehicle, a model of the detected vehicle, a presence of a passenger in the detected vehicle, a number of passengers in the detected vehicle, a license plate of the detected vehicle, and one or more businesses proximate to the GPS location of the display device.

Clause 60: The display device of clause 47 wherein the received media that is displayed changes when a sensor indicates a new detected vehicle is facing the screen.

Clause 61: The display device of clause 47 wherein the non-transitory computer readable medium having computer readable instructions thereon that further cause the computer to determine whether a detected vehicle has been previously sensed and displays a media not previously displayed for the detected vehicle.

Clause 62: The display device of clause 47 further comprising a projection system configurable to project an image.

Clause 63: The display device of clause 62 wherein the image is a holographic image.

Clause 64: The display device of clause 47 wherein the non-transitory computer readable medium having computer readable instructions thereon that further cause the computer to generate a report including two or more of duration, time of day, type of media presented, type of detected vehicle receiving the media presented, and response to media.

Clause 65: The display device of clause 47 wherein the display device is configured to receive an input message from the first device for display on the display device.

Clause 66: A display device comprising: a housing; and a screen operable to display a media content; a non-transitory computer readable medium having computer readable instructions thereon that, when executed by a computer, cause the computer to execute operations comprising analyze one or more of a physical characteristic of a detected scene captured from a camera, generate an inquiry media with a response activity for display on the display device; detect whether a response activity has been received, if a response activity is received, select a media for delivery based on the response activity, and if no response activity is received, select a generate a new inquiry with a response activity for display on the display device.

Clause 67: The display device of clause 66 further comprising a sensor and at least one camera, wherein the at least one camera, the sensor and the display face a rear of a system transporting vehicle, such that a detected vehicle behind the system transporting vehicle can view an image shown via the display device.

Clause 68: The display device of clause 66 wherein the received media comprises one or more of a quick response (QR) code, a uniform resource locator (URL), and a discount code.

Clause 69: The display device of clause 66 wherein a remuneration is associated with each media.

Clause 70: The display device of clause 66 wherein a media is pre-programmed into the device to be shown on the display device.

Clause 71: The display device of clause 70 wherein the received media is not repeated when the same detected vehicle is detected.

Clause 72: The display device of clause 66 further comprising a privacy function that limits visibility of an inquiry media when a viewing angle of a viewer is not within a target range.

Clause 73: The display device of clause 66 further comprising a panic feature operable to communicate with a third party.

Clause 74: The display device of clause 66 further wherein a delivery of the inquiry media is interrupted to provide a safety message in response to a detected parameter.

Clause 75: The display device of clause 66 wherein the received media is based on at least one of a GPS location of a system transporting vehicle, a brand of a detected vehicle, a make of the detected vehicle, a model of the detected vehicle, a presence of a passenger in the detected vehicle, a number of passengers in the detected vehicle, a license plate of the detected vehicle, and one or more businesses proximate to the GPS location of the first device.

Clause 76: The display device of clause 66 wherein the received media that is displayed changes a sensor indicates a new detected vehicle is facing the screen.

Clause 77: The display device of clause 66 wherein the non-transitory computer readable medium having computer readable instructions thereon that further cause the computer to determine whether a detected vehicle has been previously sensed and displays a media not previously displayed for the detected vehicle.

Clause 78: The display device of clause 66 further comprising a projection system configurable to project an image.

Clause 79: The display device of clause 78 wherein the image is a holographic image.

Clause 80: The display device of clause 66 wherein the system generates a report including two or more of duration, time of day, type of media presented, type of detected vehicle receiving the media presented, and response to media.

Clause 81: The display device of clause 66 wherein the system is configured to receive an input message from the first device for display on the display device.

While preferred embodiments of the present invention have been shown and described herein, it will be obvious to those skilled in the art that such embodiments are provided by way of example only. Numerous variations, changes, and substitutions will now occur to those skilled in the art without departing from the scope of the invention. For example, the use of comprise, or variants such as comprises or comprising, includes a stated integer or group of integers but not the exclusion of any other integer or group of integers. It should be understood that various alternatives to the embodiments of the invention described herein may be employed in practicing the invention. It is intended that any claims presented at any time in this application define the scope of the invention and that methods and structures within the scope of these claims and their equivalents are covered thereby.

What is claimed:

1. A mobile advertising system comprising:
a first device;
one or more cameras in communication with the first device, wherein the one or more cameras are operable to capture and transmit a scene for analysis to a user device;
one or more mountable second device wherein each of the one or more mountable second device includes a display device; and
a non-transitory computer readable medium having computer readable instructions thereon that, when executed by a computer, cause the computer to execute operations comprising
analyze one or more of a physical characteristic of a detected scene captured from at least one of the each of the one or more cameras, a behavior of a detected vehicle in the detected scene from at least one of the each of the one or more cameras, and a number of occupants in the detected vehicle,
retrieve an historical data based on one or more of a GPS location, a date, a day of week, a time, a vehicle type, an occupant type, and an occupant number,
analyze the retrieved historical data,
generate a prediction based on the analyzed physical characteristics of the detected scene and the analyzed retrieved historical data,
select a media based on the prediction,
deliver the media to the display device, and
display a received media on at least one of the display device,
wherein the first device and the second device are located in a system transporting vehicle.

2. The mobile advertising system of claim 1 wherein the media is a video segment or an image.

3. The mobile advertising system of claim 1 further comprising:
detect a presence of an adjacent vehicle; and
display the received media when at least one adjacent vehicle is detected.

4. The mobile advertising system of claim 2 wherein a length of the video segment is based at least in part on the generated prediction.

5. The mobile advertising system of claim 1 further comprising a second device having one or more second device cameras in communication with the second device, wherein the one or more second device cameras are operable to capture and transmit a second device scene for analysis to the first device, wherein the second device camera faces a rear of a system transporting vehicle, such that a detected vehicle with the second device can view an image shown via the display device.

6. The mobile advertising system of claim 1 wherein at least one of: a duration of a display time is based on a prediction, the received media comprises one or more of a quick response (QR) code, a uniform resource locator (URL), and a discount code, a remuneration is associated with each media, the remuneration correlates to a detected stop time, a media is pre-programmed into the first device to be shown on the display device, the received media is a progressive sequence of location-based advertising, the received media is not repeated when the same vehicle is detected, the delivery of the received media is interrupted to provide a safety message in response to a detected parameter, the received media is based on at least one of a GPS location, a brand of a detected vehicle, a make of the detected vehicle, a model of the detected vehicle, a presence of a passenger in the detected vehicle, a number of passengers in the detected vehicle, a license plate of the detected vehicle, and one or more businesses proximate to the GPS location of the first device, the received media displayed changes when a sensor indicates a different detected vehicle is facing the screen, the mobile advertising system determines whether a detected vehicle has been previously sensed and displays a media not previously displayed for a detected vehicle, the mobile advertising system is powered by a dual function including a restricted circuit battery system to facilitate media display when a vehicle engine is not running and one or more supplemental batteries are provided to power the system when the vehicle engine is not running, the mobile advertising system generates a report including two or more of duration, time of day, type of media presented, type of vehicle receiving the media presented, and response to media, the mobile advertising system is configured to receive an input message from the first device for display on the display device, the mobile advertising system is configured to receive an instruction from the first device wherein the instruction is based on a detected verbal instruction, the received media pertains to at least one of a number of advertisements and a type of advertisements displayed in a time period is geo-fenced, and the data pertaining to at least one of a number of advertisements and a type of advertisements displayed is at least one of recorded by the mobile advertising system and transmitted by the mobile advertising system.

7. The mobile advertising system of claim 1 further comprising at least one of: a privacy and safety function that limits visibility of the received media when a viewing angle of a viewer is not within a target range, a panic feature operable to communicate information including a distress signal and GPS coordinates to a third party, a projection system configurable to project an image.

8. The mobile advertising system of claim 7 wherein the image is a holographic image.

9. A non-transitory computer readable medium having stored thereon, computer executable instructions, which when executed by a computer, cause the computer to execute operations, the operations comprising:
analyze one or more of a physical characteristic of a detected scene captured from a camera, a behavior of a detected vehicle in the detected scene, and a number of occupants in the detected vehicle,
retrieve historical data based on one or more of a GPS location, a date, a day of week, a time, a vehicle type, an occupant type, and a vehicle occupant number,
analyze the retrieved historical data,
generate a prediction based on an analyzed physical characteristics of the detected scene and the analyzed retrieved historical data,
select a media based the generated prediction, and
deliver the media to a display device.

10. The non-transitory computer readable medium of claim 9 further comprising select at least one of a static media and a dynamic media based on the generated prediction.

11. The non-transitory computer readable medium of claim 9 wherein the media delivered is a progressive sequence of location-based advertising.

12. A display device comprising:
a housing;
a screen operable to display a media content; and
a non-transitory computer readable medium having computer readable instructions thereon that, when executed by a computer, cause the computer to execute operations comprising
analyze one or more of a physical characteristic of a detected scene captured from a camera, a behavior of a detected vehicle in the detected scene, and a number of occupants in the detected vehicle,
retrieve historical data based on one or more of a GPS location, a date, a day of week, a time, a vehicle type, an occupant type, and an occupant number,
analyze the retrieved historical data,
generate a prediction based on the analyzed physical characteristics of the detected scene and the analyzed retrieved historical data,
select a media based on the prediction,
deliver the media to the display device, and
display a received media on the display device.

13. The display device of claim 12 wherein the received media is a video segment or an image.

14. The display device of claim 12 wherein a length of a video segment is based at least in part on the generated prediction.

15. The display device of claim 12 wherein at least one of: the display device is in communication with a camera and a sensor and the screen faces a rear of a transporting vehicle, such that a detected vehicle behind the transporting vehicle can view an image shown via the screen, the received media comprises one or more of a quick response (QR) code, a uniform resource locator (URL), and a discount code, a remuneration is associated with each media, the media is pre-programmed into the display device, the received media is a progressive sequence of location-based advertising, the received media is not repeated when the same detected vehicle is detected, the delivery of the received media is interrupted to provide a safety message in response to a detected parameter, the received media is based on at least one of the GPS location of a transporting vehicle, a brand of a detected vehicle, a make of the detected vehicle, a model of the detected vehicle, a presence of a passenger in the detected vehicle, a number of passengers in the detected vehicle, a license plate of the detected vehicle, and one or more businesses proximate to the GPS location of the display device, the received media that is displayed changes when a sensor indicates a new detected vehicle is facing the screen.

16. The display device of claim 12 further comprising at least one of: a privacy function that limits visibility of the received media when a viewing angle of a viewer is not within a target range, a panic feature operable to communicate with a third party, a projection system configurable to project an image.

17. The display device of claim 12 wherein the non-transitory computer readable medium having computer readable instructions thereon that further cause the computer to determine whether a detected vehicle has been previously sensed and displays a media not previously displayed for the detected vehicle.

18. The display device of claim 16 wherein the image is a holographic image.

19. The display device of claim 12 wherein the non-transitory computer readable medium having computer readable instructions thereon that further cause the computer to generate a report including two or more of duration, time of day, type of media presented, type of detected vehicle receiving the media presented, and response to media.

20. The display device of claim 12 wherein the display device is configured to receive an input message from a first device for display on the display device.

21. A display device comprising:
a housing;
a screen operable to display a media content; and
a non-transitory computer readable medium having computer readable instructions thereon that, when executed by a computer, cause the computer to execute operations comprising
analyze one or more of a physical characteristic of a detected scene captured from a camera,
generate an inquiry media with a response activity for display on the display device,
detect whether a response activity has been received,
if a response activity is received, select a media for delivery based on the response activity, and
if no response activity is received, select a generate a new inquiry with a response activity for display on the display device.

22. The display device of claim 21 further comprising at least one of: a sensor and at least one camera, wherein the at least one camera, the sensor and the display face a rear of a system transporting vehicle, such that a detected vehicle behind the system transporting vehicle can view an image shown via the display device, a privacy function that limits visibility of an inquiry media when a viewing angle of a viewer is not within a target range, a panic feature operable to communicate with a third party, a projection system configurable to project an image.

23. The display device of claim 21 wherein at least one of: the received media comprises one or more of a quick response (QR) code, a uniform resource locator (URL), and a discount code, a remuneration is associated with each media, a media is pre-programmed into the device to be shown on the display device, the received media is not repeated when the same detected vehicle is detected, a delivery of the inquiry media is interrupted to provide a safety message in response to a detected parameter, the received media is based on at least one of a GPS location of a system transporting vehicle, a brand of a detected vehicle, a make of the detected vehicle, a model of the detected vehicle, a presence of a passenger in the detected vehicle, a number of passengers in the detected vehicle, a license plate of the detected vehicle, and one or more businesses proximate to the GPS location of a first device, the received media that is displayed changes a sensor indicates a new detected vehicle is facing the screen.

24. The display device of claim 21 wherein the non-transitory computer readable medium having computer readable instructions thereon that further cause the computer to determine whether a detected vehicle has been previously sensed and displays a media not previously displayed for the detected vehicle.

25. The display device of claim 22 wherein the image is a holographic image.

26. The display device of claim 21 wherein the system generates a report including two or more of duration, time of day, type of media presented, type of detected vehicle receiving the media 2 presented, and response to media.

27. The display device of claim 21 wherein the system is configured to receive an input message from a first device for display on the display device.
